(19) United States
(12) Patent Application Publication
(10) Pub. No.: US 2025/0271683 A1
(43) Pub. Date: Aug. 28, 2025

(54) DISPLAY DEVICE

(71) Applicant: Continental Automotive Technologies GmbH, Hannover (DE)

(72) Inventor: Christian Junge, Frankfurt am Main (DE)

(73) Assignee: Continental Automotive Technologies GmbH, Hannover (DE)

(21) Appl. No.: 18/859,841

(22) PCT Filed: Apr. 17, 2023
(86) PCT No.: PCT/DE2023/200077

§ 371 Date: Oct. 24, 2024

(30) Foreign Application Priority Data
Apr. 27, 2022 (DE) 10 2022 204 111.9

(51) Int. Cl. G02B 27/28; G02B 27/01; G02B 27/09

(52) U.S. Cl. CPC G02B 27/286; G02B 27/0101; G02B 27/0961; G02B 27/0977

(57) ABSTRACT

The disclosure relates to a display device comprising a display panel for linearly polarized light, a light source for unpolarized light, and a polarization recycler. The polarization recycler comprises a microlens arrangement, a perforated mask with a reflective embodiment on its side facing away from the microlens arrangement, a retarder, and a reflective polarizer. The microlenses of the microlens arrangement are arranged without gaps.

### CROSS REFERENCE TO RELATED APPLICATIONS

This US patent application claims the benefit of PCT patent application No. PCT/DE2023/200077, filed Apr. 17, 2023, which claims the benefit of German patent application No. 10 2022 204 111.9, filed Apr. 27, 2022, both of which are hereby incorporated by reference.

### TECHNICAL FIELD

The present disclosure relates to a display device comprising a display panel for linearly polarized light, as illumination a light source for unpolarized light, and a polarization recycler.

### BACKGROUND

Polarization recycling is a widespread method used in display devices to maximize the use-efficiency of unpolarized light from the illumination. In polarization recycling, unpolarized light is converted with as little loss as possible into polarized light with a desired polarization. Light with the desired polarization passes through the polarization recycler while light with a polarization orthogonal thereto is largely converted into light with the desired polarization by the polarization recycler. Thus virtually all of the incident light leaves the polarization recycler as light with the desired polarization. Losses that arise in a conventional polarizer, which does not allow light to pass with the unwanted polarization but absorbs or reflects the latter, are consequently avoided. Since display devices generally comprise a display panel for linearly polarized light and therefore require polarized incoming light, illumination light with the unused polarization direction is often filtered by a reflective polarizer and converted into the correct polarization by way of scattering, and hence rendered usable for the display panel. This variant works both in the case of edge-lit systems, in which the light source shines into a light guide from the side and the latter then outcouples the light in the direction of the display panel, i.e. illuminates said display panel indirectly, and in the case of direct illumination. As an alternative to scattering in the latter case, use can also be made of a method in which polarization recycling is achieved with the aid of polarizing beam splitters and retarder foils.

US 2005/0270439 A1 and WO 2006/038417 A1 are examples of indirect illumination and polarization recycling by means of a reflective polarizer and scattering. US 2004/0263789 A1 and US 2013/0286479 A1 are examples of direct illumination and polarization recycling by means of a polarizing beam splitter and retarder.

The fact that the scattering-based approach in many applications leads to an inefficient, very broad angle distribution of light, for example in the case of head-up displays (which are frequently also abbreviated as HUDs), should be considered a disadvantage of the known solutions. The approach by way of polarizing beam splitters is very complicated in implementation from a technical point of view and requires much space.

US 2018/0299730 A1 has disclosed a display device comprising a display panel for linearly polarized light, a light source for unpolarized light, and a polarization recycler. In this case, the polarization recycler comprises the following in succession in the beam path coming from the light source: a microlens arrangement, a perforated mask with a reflective embodiment on its side facing away from the microlens arrangement, a retarder, and a reflective polarizer.

A display device improved in relation thereto and having polarization recycling is sought after.

### SUMMARY

A display device according to the disclosure comprises a microlens arrangement in which the microlenses are arranged without gaps. These microlenses are arranged side by side such that the transition region between two microlenses takes up as little space as possible and is not present in the ideal case. The gap-free arrangement of the microlenses ensures that all of the light coming from the light source is used directly. This avoids losses that might occur in the case of potential multiple reflections of the light which in the case of spaced apart microlenses is incident on the microlens intermediate space and reflected there. The microlenses focus incident light such that the latter may pass through the holes in the perforated mask. The component of the light reflected by the reflective polarizer is reflected by the reflecting region of the perforated mask and has the suitable polarization for the display panel after multiple passages, for example two passages, through the retarder. This enables efficient polarization recycling without much outlay, in the case of which virtually all of the unpolarized light created by the light source is supplied to the display panel as linearly polarized light. A birefringent/retarding element is provided as a retarder. For example, this is a quarter-wave plate which converts linearly polarized light into circular polarization if the axis of the quarter-wave plate is suitably aligned. In this case, two passages are sufficient to obtain a rotation of the polarization direction through 90°. The reflective polarizer is aligned such that the light passing therethrough has the same polarization direction as required by the display panel on its input side.

According to the disclosure, the microlenses of the microlens arrangement are configured such that they convert parallel incoming light beams into outgoing light beams with a conical distribution that has a defined opening angle. This is advantageous in that an opening angle characteristic as desired for the display device is already provided by the polarization recycler. The focal length of the microlenses and the arrangement thereof with regards to the perforated mask are suitably chosen depending on the desired opening angle characteristic. The opening angle characteristic is even maintained during the polarization recycling. Thus the arrangement according to the invention may be used in display units already designed for parallel incoming beams and may for example replace a complicated or less efficient polarization recycler therein. In a practical implementation, the incoming beams will not be ideally parallel, and the outgoing beams will not form an ideal cone either. Depending on the main face of the microlenses, which may be round, rectangular, hexagonal, etc., the conical distribution also approximately has a corresponding cross section. Intermediate regions, in which light is blocked or passing light is not refracted in accordance with the microlens, remain on the microlens arrangement between the microlenses in the case of a round cross section. Such a microlens arrangement might be cost-effectively producible and creates light cones with a round cross section but leaves light incident on the intermediate regions unused. By contrast, microlenses with a different cross section may be arranged to cover the area, and this increases the proportion of usable light but is also accompanied by light cones with corresponding cross sections.

Advantageously, the microlens arrangement comprises a main body with two substantially parallel main faces arranged at a distance from one another, the microlenses are arranged on one main face thereof, and the perforated mask is arranged on the other main face thereof. The distance of the microlens arrangement from the perforated mask and the relative alignment of these two with respect to one another are ensured by the production of the microlens arrangement. Hence, there is no need to subsequently align these two with respect to one another, and sources of errors are consequently reduced. The perforated mask is at a defined distance from the microlenses; it is possible to manage without a complicated adjustment that would arise in the case of elements that are manufactured separately and subsequently assembled.

According to a configuration of the disclosure, the perforated mask is arranged in a focal plane of the microlens arrangement. This allows the perforated mask to have very small holes since in the ideal case the light cone is punctiform in the focal plane, and even in reality the light cones created by the microlenses have their region of smallest diameter there. Holes that are as small as possible mean a reflecting area that is as large as possible, and hence the smallest possible light losses. Only the light reflected by the reflecting polarizer and incident on the holes of the perforated mask is not available for polarization recycling. The locations of the free sites of the perforated mask, i.e. of the holes thereof, in this case correspond to the focal points of the microlens arrangement.

According to a configuration of the disclosure, the perforated mask is a reflective coating arranged on a side facing away from the microlens arrangement. Such a coating may be produced cost-effectively, for example by a printing method.

According to a development of the disclosure, the main body is embodied as a foil. The microlenses are situated on one side of the foil, and the perforated mask as a reflecting coating is arranged on the other side. Such foils may be produced cost-effectively but nevertheless with precisely pre-definable properties.

According to one development, the display device comprises a transparent support with two substantially parallel main faces arranged at a distance from one another, the perforated mask is arranged on one main face thereof, and the retarder is arranged on the other main face thereof. This allows the retarder to be embodied as a foil that is too thin to support itself. The latter is then arranged on the thicker support, for example by lamination. The support then serves as a propagation path. According to a variant of this development, both the retarder and the reflective polarizer are arranged on this main face of the support. This development is advantageous in that even the retarder and/or the reflective polarizer are arranged at a defined distance from and with a defined alignment to the perforated mask. Therefore, these need not be aligned and adjusted relative to one another during the installation into the display device and are not subject to any unwanted displacements from the adjusted position during operation either. Advantageously, the entire polarization recycler from the microlens arrangement to the reflective polarizer is pre-produced as a sandwich. The combination of microlens arrangement and support increases the stability and allows the microlens arrangement to be designed to be particularly thin even though it would lack the required stability on its own, when not connected to the support, in that case.

A stable arrangement of the retarder, especially if the latter is embodied as a foil or as a coating system, can advantageously also be obtained by virtue of the retarder being arranged on the reflective polarizer, for example laminated or coated thereon, without these two being connected by a support to the perforated mask and microlens arrangement. This still allows the distance between the perforated mask and the reflective polarizer to be set during a late production stage, and this may be desired under certain boundary conditions.

According to a development, the microlenses of the microlens arrangement have a rectangular aperture. This leads to the conical distribution of the outgoing light beams having an approximately rectangular cross section. Such a cross section is often desired, for example for illuminating the eyebox in a head-up display. In that case, the conical distribution is for example described by way of the opening angles of its shortest and its longest semi-axis.

According to a development, the microlenses of the microlens arrangement are arranged in decentered fashion. The decentration leads to a global deflection of the beam of light. The polarization recycler may consequently also be used to additionally deflect the incident light. If the decentration of the microlenses is not constant but varies over the component, then it is also possible to obtain a global lens effect, e.g. a diverging lens which does not deflect the light at the center of the polarization recycler and enables an ever stronger deflection to the sides.

According to an alternative variant, the perforated mask comprises holes arranged in an irregular structure. In this case, each of these holes is assigned a microlens with the same lens geometry. However, the microlens apertures have unequal areas. The irregular distribution of the aperture portions leads to variable angle distributions for each microlens and thus entails a diffuser effect. A diffuser with polarization recycling is realized according to this development.

According to a configuration of the disclosure, the reflective polarizer is aligned parallel to the perforated mask such that the reflective light component is rotated in terms of its polarization by two passages through the retarder and is superimposed on the directly transmitted component at the reflective polarizer as a result of the reflection at the perforated mask. Efficiency-increasing polarization recycling is thus obtained.

### BRIEF DESCRIPTION OF THE DRAWINGS

Further advantageous configurations of the disclosure are also given in the following description of embodiments, wherein:

FIG. 1 schematically shows a head-up display according to the prior art for a motor vehicle;

FIG. 2 schematically shows a display device of a head-up display;

FIG. 3 schematically shows a display device according to the disclosure of a head-up display;

FIG. 4 schematically shows a further display device according to the disclosure of a head-up display;

FIG. 5 shows a polarization recycler;

FIG. 6 shows a microlens arrangement with centered microlenses;

FIG. 7 shows a microlens arrangement with decentered microlenses;

FIG. 8 shows a polarization recycler with decentered microlenses; and

FIG. 9 shows a plan view of a microlens arrangement.

### DETAILED DESCRIPTION

For a better understanding of the principles of the present disclosure, embodiments of the disclosure are explained in more detail below with reference to the figures. Identical reference signs are used for identical or functionally identical elements in the figures and are not necessarily described again for each figure. It is to be understood that the disclosure is not restricted to the embodiments represented, and that the features described may also be combined or modified without departing from the scope of protection of the disclosure, as defined in the appended claims.

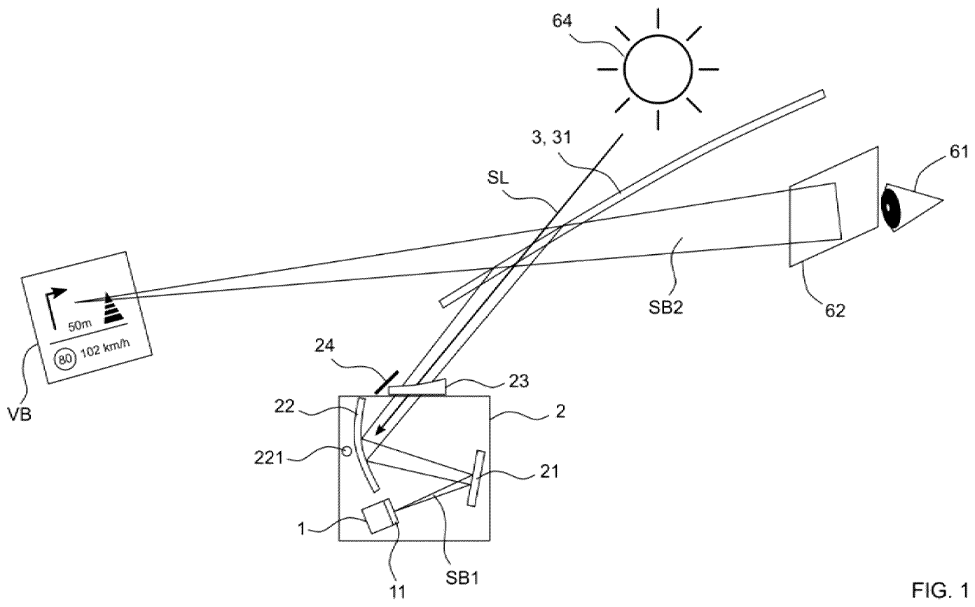

FIG. 1 shows a schematic diagram of a head-up display for a motor vehicle according to the prior art. The head-up display comprises a display device 1, an optical unit 2, and a mirror unit 3. A beam of rays SB1 emanates from a display panel 11 and is reflected by a first mirror 21 onto a curved mirror 22, which reflects it in the direction of the mirror unit 3. The mirror unit 3 is represented here as a windshield 31 of a motor vehicle. From there, the beam of rays SB2 travels in the direction of an eye 61 of a viewer.

The viewer sees a virtual image VB that is located outside the motor vehicle, above the engine hood or even in front of the motor vehicle. Due to the interaction between the optical unit 2 and the mirror unit 3, the virtual image VB is an enlarged representation of the image displayed by the display panel 11. A speed limit, the current vehicle speed and navigation instructions are symbolically represented here. As long as the eye 61 is within the eyebox 62 indicated by a rectangle, all elements of the virtual image are visible to the eye 61. If the eye 61 is outside the eyebox 62, the virtual image VB is visible only partially or not at all to the viewer. The larger the eyebox 62, the less restricted the viewer is when choosing their seating position.

The curvature of the curved mirror 22 is adapted to the curvature of the windshield 31 and ensures that the image distortion is stable over the entire eyebox 62. The curved mirror 22 is rotatably mounted by means of a mounting 221. The rotation of the curved mirror 22 that this allows thereby makes it possible to displace the eyebox 62 and thus to adapt the position of the eyebox 62 to the position of the eye 61. The first mirror 21 serves to ensure that the path traveled by the beam of rays SB1 between the display panel 11 and the curved mirror 22 is long and, at the same time, that the optical unit 2 is nevertheless compact. The optical unit 2 is delimited from the environment by a transparent cover 23. The optical elements of the optical unit 2 are thus protected, for example against dust located in the interior of the vehicle. Anti-glare protection 24 serves to reliably absorb the light reflected via the interface of the cover 23 so that the viewer is not dazzled. In addition to the sunlight SL, the light from another stray light source 64 may also reach the display panel 11.

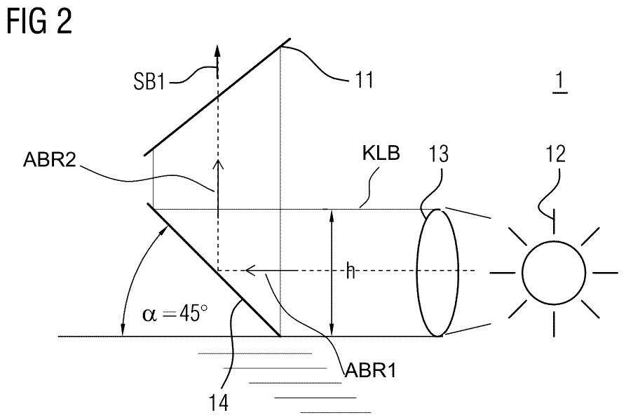

FIG. 2 schematically shows the display device 1 of a head-up display. It shows the light source 12, whose light is collimated by a collimator 13. The collimated beam of light KLB has in the image plane a height h in the direction perpendicular to its propagation direction ABR1. The beam of light is reflected by a mirror 14 arranged at an angle of α=45° to the propagation direction ABR1 and radiates through the display panel 11 in its propagation direction ABR2 aligned at an angle of 90° to the propagation direction ABR1 and enters from there the optical unit 2 (not illustrated here) in the form of the beam of rays SB1. The display panel 11 is not arranged at a right angle to the propagation direction ABR2, but at an angle deviating from 90°, which is shown here as deviating very markedly from 90°. The use of the mirror 14 reduces the installation height in the propagation direction ABR2. Other embodiments manage without such a mirror; the two propagation directions ABR1 and ABR2 then coincide.

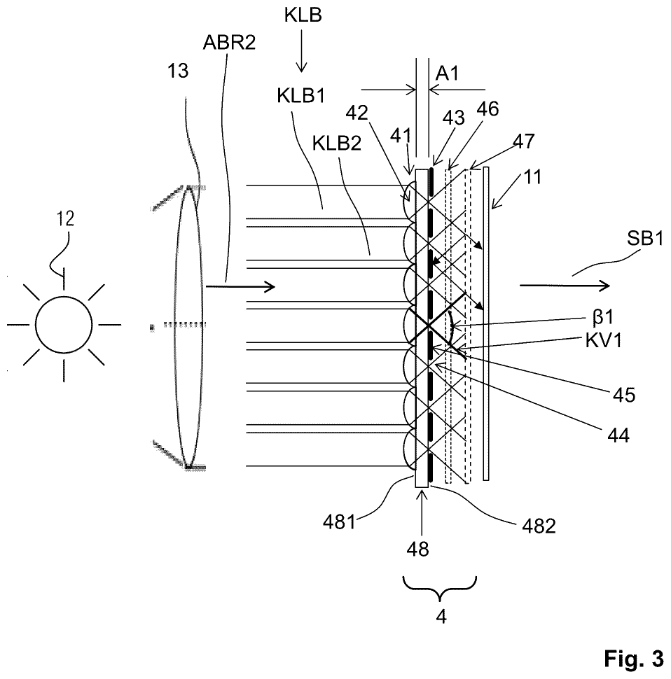

FIG. 3 schematically shows a display device 1 according to the disclosure of a head-up display. To the left, it is possible to identify the light source 12 followed by a collimator 13 which creates a collimated beam of light KLB with parallel light beams. A plurality of component beams of rays KLB1, KLB2, . . . of the collimated beam of light KLB are shown here. The collimated beam of light KLB is incident on a polarization recycler 4 and leaves the latter as linearly polarized light which is incident on the display panel 11, is provided with image information by the latter, and leaves said display panel as beam of rays SB1.

The polarization recycler 4 comprises a microlens arrangement 41 which consists of many microlenses 42. The microlenses are embodied as converging lenses. A perforated mask 43 is situated downstream of the microlens arrangement 41 in the beam direction. Said perforated mask has a reflective embodiment on its side 45 facing away from the microlens arrangement 41. A retarder 46 is situated downstream of the perforated mask 43 in the beam direction. Said retarder is embodied as a quarter-wave plate, for example. Other retardation elements that retard or modify the polarization and the phase of light can also be provided as retarder 46. A reflective polarizer 47 is situated downstream of the retarder 46 in the beam direction. The polarization recycler 4 thus comprises the elements of microlens arrangement 41, perforated mask 43, retarder 46, and reflective polarizer 47. The microlens arrangement 41 is situated on a first main face 481 of a main body 48, and the perforated mask 43 is arranged on the second main face 482 of said main body. The main body 48 is transparent and for example consists of the same material as the microlenses 42. In a configuration, the microlenses 42 are embodied in one piece with the main body 48. According to another variant, the main body 48 is a glass substrate, and the microlenses 42 are applied to the glass substrate using a nanoimprinting method. The main faces 481, 482 are at a distance A1 from one another which corresponds to the focal length of the microlenses 42. In a configuration, the main body 48 is a foil, microlenses are impressed on the first main face 481 of said foil, and a reflective coating provided with holes 44 is applied to the second main face 482 thereof.

It is possible to identify that the microlenses 42 of the microlens arrangement 41 are arranged without gaps. Each of the microlenses 42 converts the parallel incoming light beams of the collimated beam of light KLBx (x=1, 2, . . . ) incident thereon into outgoing light beams that have a conical distribution KV1. The conical distribution KV1 has an opening angle β1. The incoming light beams are focused, with the focal plane of the outgoing light beams being located in the plane of the perforated mask 43. The outgoing light beams pass through the retarder 46. Since the outgoing light beams, like the incoming light beams, do not have any preferred polarization, they do not have any preferred polarization after passing through the retarder 46 either. Upon incidence on the reflective polarizer 47, the latter is passed through only by the component that is aligned in accordance with the reflective polarizer 47, while the component polarized perpendicular thereto is reflected. The reflected component passes through the retarder 46, is reflected by the reflecting side 45 of the perforated mask 43, and passes through the retarder 46 again. After passing through the retarder 46 twice, the polarization direction is rotated through 90°, and so the reflective polarizer 47 is now passed through. Hence, apart from the component incident on the holes 44 in the perforated mask 43, the light originally reflected by the reflective polarizer 47 is rotated in terms of its polarization and supplied to the display panel 11 with the correct polarization. The latter is a display panel 11 provided for linearly polarized light, for example a liquid crystal display (LCD). The distance between the perforated mask 43 and the reflective polarizer 47 is chosen such that the back-reflected portion of the beam of rays KV1 has a diameter upon incidence on the reflective side 45 of the perforated mask 43 that is comparable to that of the microlenses 42 so that the ratio of illuminated coated area and hole diameter of the perforated mask 43 is as large as possible. The beam of rays SB1 which leaves the display panel 11 to the right in the image has the conical distribution KV1 specified by the microlenses 42. In this case, the transmission axis of the reflective polarizer is aligned such that the polarization of the transmitted light is aligned with the polarization axis of the display panel 11. Light of the corresponding perpendicular polarization is reflected.

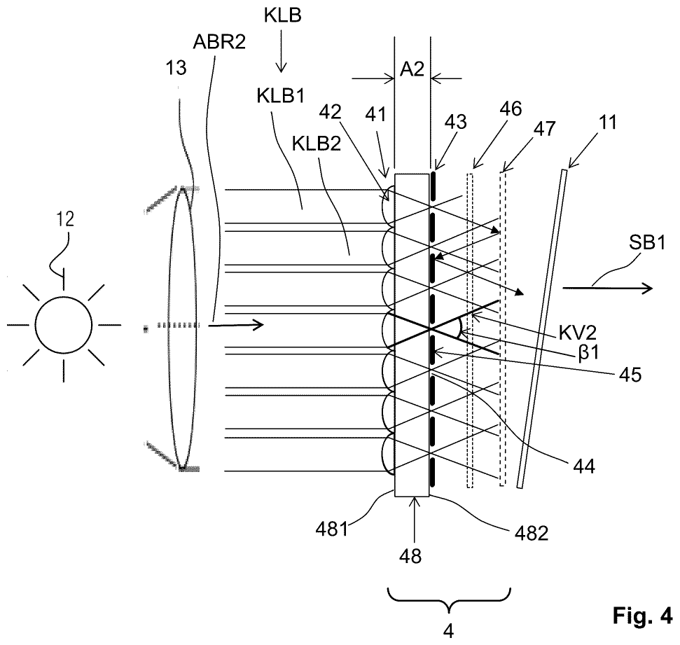

FIG. 4 schematically shows a further embodiment of a display device according to the disclosure of a head-up display. It corresponds substantially to the one depicted in FIG. 3, with the microlenses 42 having a different focal length. The distance A2 between the first main face 481 and second main face 482 is therefore larger than what is shown in the previous figure. Hence there also is a different opening angle β2 for the conical distribution KV2. Thus, a conical distribution KV with a desired opening angle β can be set by modifying the focal length of the microlenses 42 and the distance A2.

In this embodiment, the display panel 11 is depicted at an angle to the propagation direction ABR2 of the light that deviates from 90°. Such an arrangement is preferred, especially in certain applications, for example in the head-up display.

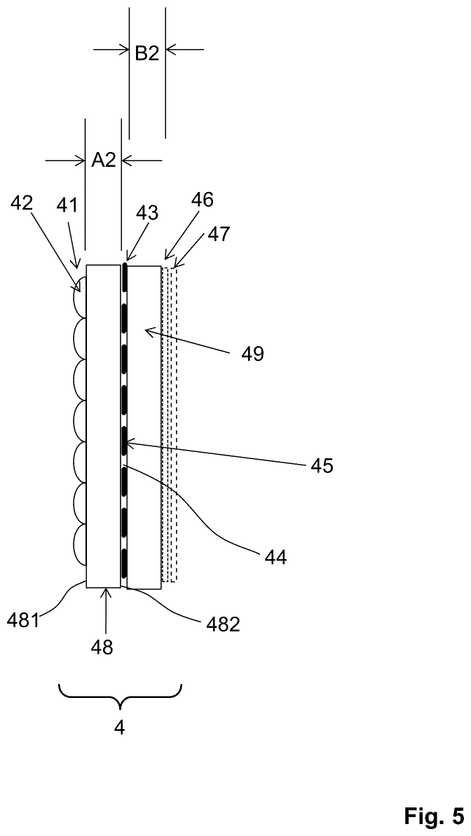

FIG. 5 shows a polarization recycler 4 that corresponds to the one shown in FIG. 4, albeit embodied in one piece. As described above, the microlens arrangement 41 is arranged on a first main face 481 of a main body 48. The perforated mask 43 is situated on the other main face 482 of the main body 48. The perforated mask 43 is connected to a support 49 on the side of said perforated mask facing away from the main body 48. The retarder 46, which is adjoined by the reflective polarizer 47, is arranged on the other main face of the support 49. The support 49 has a thickness B2. In the exemplary embodiment shown here, all elements of the polarization recycler 4 are connected to form a sandwich-like component. Other embodiment variants not shown here provide for not all of these elements to be connected to one another. For example, in one variant, the retarder 46 and the reflective polarizer 47 are connected to one another, and the microlens arrangement 41 is connected to the main body 48 and the perforated mask 43. These two assemblies are arranged at a distance from one another but not areally connected to one another. A support 49 is dispensed with in this variant. Another variant provides for the support 49 to be areally connected to either the retarder 46 or the perforated mask 43, but to be arranged at a distance from the respective other component. In this case, the support 49 contributes to the increased stability of the component areally connected therewith in each case.

According to a modification not shown here, the retarder 46 is directly arranged on the perforated mask 43, preferably by way of lamination. The reflective polarizer 47 is then arranged at a distance from the retarder 46. According to one variant, a support 49 is arranged between the retarder 46 and the reflective polarizer 47 in this case, too. According to another variant, there is merely a layer of air therebetween. In that case, the elements not areally connected to one another are fastened and aligned by means of elements (not depicted here) arranged on the outside, for example by means of housing elements. The support 49 may also be designed as a transparent optical foil, the thickness B2 of which in comparison with the distance A2 between the main faces 481, 482 is substantially smaller than depicted here.

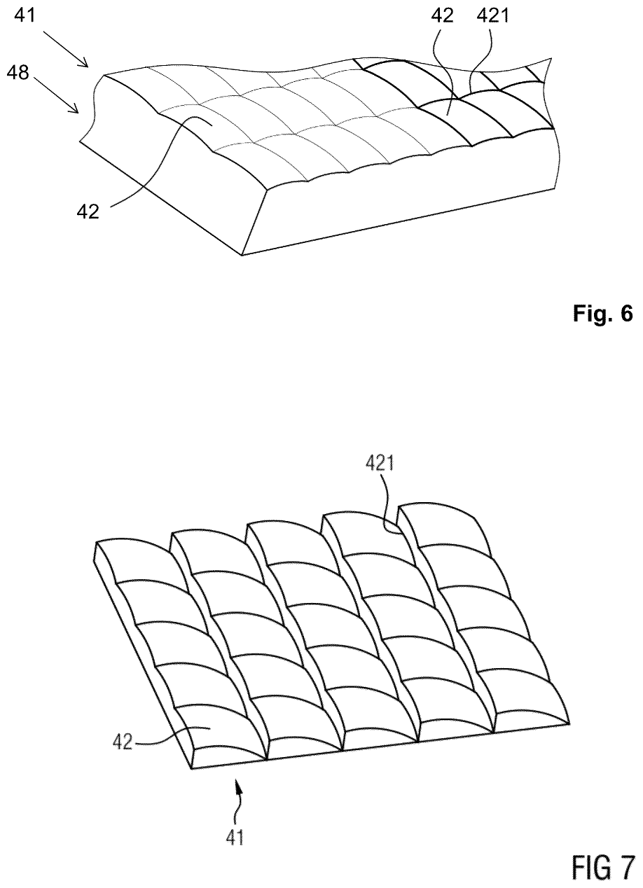

FIG. 6 shows a microlens arrangement 41, in which the microlenses 42 have a rectangular main face and are arranged in centered fashion. In this case, the microlens arrangement 41 is embodied in one piece with a main body 48. The microlenses 42 in each case abut against one another at contact lines 421. The contact lines 421 framing a respective microlens 42 form a rectangle in a plan view. The microlenses 42 thus have a rectangular aperture. The perforated mask 43 situated below the main body 48 is not depicted here. In plan view, its holes 44 are situated at the center of the respective microlens 42 which thus is centered.

FIG. 7 shows a microlens arrangement 41, in which the microlenses 42 have a rectangular main face and are arranged in decentered fashion. The microlens arrangement 41 is shown without main body 48 here. The microlenses 42 in each case abut against one another at contact lines 421. The contact lines 421 framing a respective microlens 42 form a rectangle in a plan view. The microlenses 42 thus have a rectangular aperture. The perforated mask 43 situated below the main body 48 is not depicted here. In plan view, its holes 44 are not situated at the center of the rectangular aperture of the respective microlens 42. The microlenses 42 shown here are thus decentered.

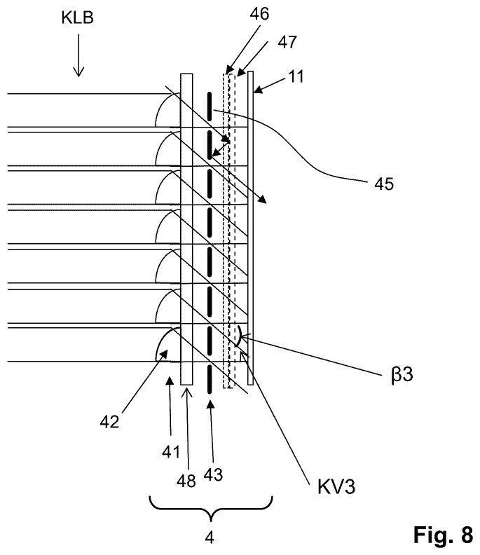

FIG. 8 shows a polarization recycler 4 with decentered microlenses 42. The polarization recycler 4 comprises a microlens arrangement 41 which consists of many microlenses 42. The microlenses 42 are embodied as converging lenses and have a similar decentered arrangement as shown in relation to FIG. 7. A perforated mask 43 is situated downstream of the microlens arrangement 41 in the beam direction. Said perforated mask has a reflective embodiment on its side 45 facing away from the microlens arrangement 41. A retarder 46 is situated downstream of the perforated mask 43 in the beam direction. A reflective polarizer 47 is situated downstream of the retarder 46 in the beam direction. The polarization recycler 4 thus comprises the elements of microlens arrangement 41, perforated mask 43, retarder 46, and reflective polarizer 47. The microlens arrangement 41 is situated on a first main face 481 of a main body 48, and the perforated mask 43 is arranged on the second main face 482 of said main body. The main body 48 is transparent and preferably consists of the same material as the microlenses 42. In a configuration, the microlenses 42 are embodied in one piece with the main body 48.

It is possible to identify that the microlenses 42 of the microlens arrangement 41 are arranged without gaps. Each of the microlenses 42 converts the parallel incoming light beams of the collimated beam of light KLB incident thereon into outgoing light beams that have a conical distribution KV3. The conical distribution KV3 has an opening angle β3 and a deflection/tilt of the propagation axis through an angle that depends on the degree of decentration of the microlenses 42. The incoming light beams are focused, with the focal plane of the outgoing light beams being located in the plane of the perforated mask 43. The outgoing light beams pass through the retarder 46. Since the outgoing light beams, like the incoming light beams, do not have any preferred polarization, they do not have any preferred polarization after passing through the retarder 46 either. Upon incidence on the reflective polarizer 47, the latter is passed through only by the component that is aligned in accordance with the reflective polarizer 47, while the component polarized perpendicular thereto is reflected. The reflected component passes through the retarder 46, is reflected by the reflecting side 45 of the perforated mask 43, and passes through the retarder 46 again. After passing through the retarder 46 twice, the polarization direction is rotated through 90°, and so the reflective polarizer 47 is now passed through. Hence, apart from the component incident on the holes 44 in the perforated mask 43, the light originally reflected by the reflective polarizer 47 is rotated in terms of its polarization and supplied to the display panel 11 with the correct polarization. The latter is a display panel 11 provided for linearly polarized light, for example a liquid crystal display (LCD). The beam of rays which leaves the display panel 11 to the right in the image has the conical distribution KV3 specified by the microlenses 42. In this case, the transmission axis of the reflective polarizer is aligned such that the polarization of the transmitted light is aligned with the polarization axis of the display panel 11. Light of the corresponding perpendicular polarization is reflected.

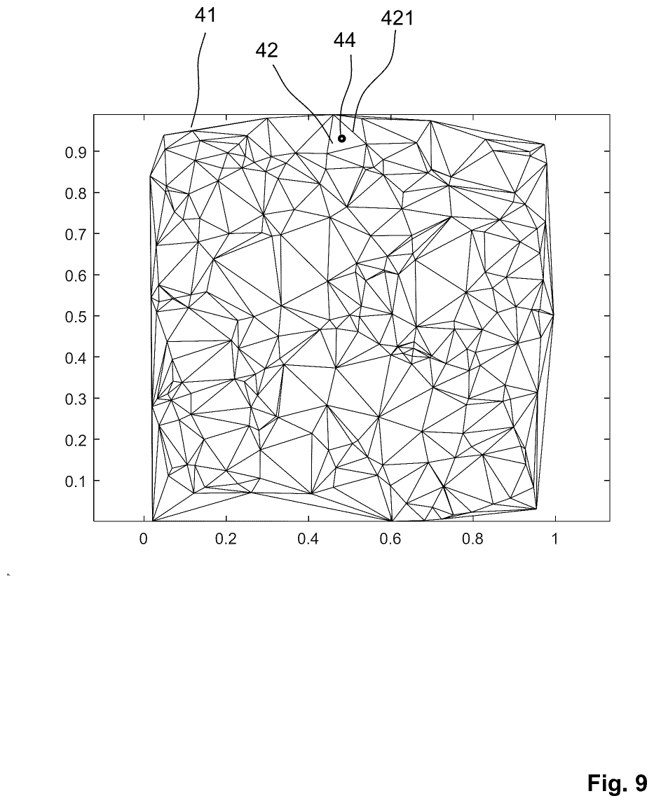

FIG. 9 shows a plan view of a microlens arrangement 41 with an irregular structure. The microlenses 42 each have a triangular main face and are surrounded by contact lines 421 arranged in a triangular fashion. A circle is plotted at the center of a microlens 42 selected here by way of example, and this circle indicates the location—in this case below the plane of the drawing-at which the focus of the microlens is situated, and where a hole 44 of the perforated mask arranged according to the invention is situated. In the microlens arrangement 41 shown here, many such microlenses 42 are arranged in irregularly distributed fashion with an irregular triangular aperture area and the same optical properties. Their arrangement corresponds to an irregular structure in which the holes 44 of the perforated mask 43 are arranged. Only one of the holes 44 is indicated here for reasons of clarity. Each of the holes 44 is assigned a microlens 42. In the ideal case, the arrangement of the holes 44 represents a random distribution.

The drawing shows a microlens arrangement 41 with randomly distributed microlenses 42 with a triangular aperture. Other apertures allowing a whole-area coverage may also be advantageously used here, for example quadrilateral, hexagonal or, in general, n-gonal apertures, with n=3, 4, 5, . . . , or combinations thereof.

In a sectional illustration, the beam paths appear similar to those shown in FIG. 8, albeit with random dimensions. Each triangle formed by three contact lines 421 still has a curved lens surface, and so all parallel light beams incident thereon converge at a focal point. Only the locations of the focal points, and hence the locations of the holes 44, now follow the distribution of these triangles.

Since all focal points are located in the plane of the perforated mask 43, there are jumps between the individual triangles at the contact lines 421 between two microlenses 42 since the lens surfaces are of course randomly cut here and are not matched to the neighboring elements. However, since each element builds on the same lens surface, the vertices of the lenses should always be at the same level provided they are located within the respective triangle. In this case, the apertures are triangular but otherwise “random” with respect to size and orientation. N-gons with N=3, 4, 5, . . . are likewise possible here. As is a mixture of N-gons with different values of N. Likewise, curved boundaries, i.e. curved contact lines 421, are not precluded here, although they may be difficult to produce.

The essence of the disclosure lies in a microlens array, the microlens arrangement 41, made of converging lenses, the microlenses 42. The microlens arrangement 41 creates the desired angle distribution with the opening angle β from parallel illumination light. In addition to the opening angle, many further properties of the light distribution, e.g. the intensity distribution for different angle ranges, may also be defined by way of the shape and aperture of the lens surface. The converging lenses focus the light such that an array of focal points arises at a short distance A from the microlens 42. If the microlenses 42 are applied to the underside of a foil, the main body 48 in this case, and the lens parameters are chosen accordingly, then the focal point of each microlens may be placed in the vicinity of the second main face 482, the surface of the foil. The second main face 482, i.e. the top side of the foil, has a highly reflective coating in all regions not containing a focal point. Thus, it forms a type of perforated mask 43, through which the light is threaded with the aid of the microlenses 42. Following the passage through the component, the light is initially transmitted through a quarter-wave plate, the retarder 46. Then, the polarization not used by the display panel 11 is reflected back by a reflective polarizer 47, and this polarization is incident on the reflecting side 45 of the perforated mask 43 again. However, since the light now propagates divergently on account of being focused previously, the diameter of each component beam KV will have broadened significantly when incident on the perforated mask 43 again, and the majority of said component beam will be incident on the coated part of the perforated mask 43 and will be reflected back in the direction of the display panel 11. The distance between the perforated mask 43 and the reflective polarizer 47 is chosen to be so large in accordance with the dependence on the opening angle β that the reflected light will illuminate the entirety of the perforated mask 43. As a result of two passages through the quarter-wave plate (or multiple passages in the case of a retarder with a different retardation than a quarter wavelength), the polarization is now rotated such that the light can pass through the reflective polarizer 47 and thus contributes to the overall brightness. Consequently, a very compact structure and a retention of the angle distribution of the microlens arrangement 42 are obtained, and no complicated beam splitter components are required. A display device according to the disclosure may likewise achieve an increase in efficiency in a display system similar to that of a head-up display, in which the angle distribution of the outgoing light should be controlled very precisely.

In contrast to a known solution, in which incoming light beams coming from a plurality of light sources are undirected and converted into outgoing light beams with a conical distribution by way of the length and diameter of drilled holes through which they pass, the disclosure provides for the conversion of collimated or parallel incoming light beams into outgoing light beams with a conical distribution. The solution according to the disclosure is thus suitable for a closed beam of parallel light in particular, and works without directly increasing the cross-sectional area of the light. Naturally, the étendue increases in the process. During further propagation there is an increase in the cross-sectional area; however, this increase may be neglected since the display panel 11 directly follows behind the polarization recycler 4 in the embodiments. In other words: The polarization recycling occurs in the available area of the beam of rays in this case. If work is carried out alternatively with a beam splitter, then the area doubles because the incoming beam is split into two component beams that cannot be combined again. The étendue is a physical quantity which in simplified terms arises from the angle distribution at each point of the beam of light and its cross-sectional area. A conservation law states that étendue can always only stay the same or increase during the passage through an optical system. In this case, there are incoming beams of a parallel beam of light KLB (angle distribution) ˜0° with a certain cross-sectional area and associated étendue. The divergence angle is increased by the microlens arrangement 41, and this increases the étendue.

To allow the known system to be efficient, the reflection in the lower part, i.e. below the plate by the light sources, would have to be reflecting with very low losses since a majority of the light will require very many reflections until it passes through the drilled holes. The present invention is suitable, in particular, to be integrated in already existing beam of light polarization recycling.

According to the disclosure, the perforated mask 43 is formed by a reflective coating with holes present therein. By contrast, elongate drilled holes are present in a thick plate in a known solution. This plate has a reflecting coating that is not embodied continuously at the sites of the drilled holes but leaves the drilled holes open.

One advantage of the solution according to the disclosure is that, inter alia, the microlens arrangement 41 enables the creation of almost any desired light distribution in the angular space and this may be combined efficiently with the polarization recycling.

1. A display device comprising a display panel for linearly polarized light, a light source for unpolarized light, and a polarization recycler, the polarization recycler comprising:
a microlens arrangement;
a perforated mask with a reflective embodiment on its side facing away from the microlens arrangement;
a retarder; and
a reflective polarizer,
wherein the microlenses of the microlens arrangement are arranged without gaps.

2. The display device as claimed in claim 1, wherein the microlenses of the microlens arrangement convert parallel incoming light beams into outgoing light beams with a conical distribution that has a defined opening angle.

3. The display device as claimed in claim 1, wherein the microlens arrangement comprises a main body with two substantially parallel main faces arranged at a distance from one another, the microlenses are arranged on one main face thereof, and the perforated mask is arranged on the other main face thereof.

4. The display device as claimed in claim 1, wherein the perforated mask is arranged in a focal plane of the microlens arrangement.

5. The display device as claimed in claim 1, wherein the perforated mask is embodied as a reflective coating.

6. The display device as claimed in claim 3, wherein the main body is embodied as a foil.

7. The display device as claimed in claim 1, further comprising a transparent support with two substantially parallel main faces arranged at a distance from one another, wherein the perforated mask is arranged on one main face thereof, and wherein either the retarder or both the retarder and the reflective polarizer are arranged on the other main face thereof.

8. The display device as claimed in claim 1, wherein the microlenses of the microlens arrangement have a rectangular aperture.

9. The display device as claimed in claim 1, wherein the microlenses of the microlens arrangement are arranged in decentered fashion.

10. The display device as claimed in claim 1, wherein the perforated mask comprises holes arranged in an irregular structure, and each of these holes is assigned a microlens.

11. The display device as claimed in claim 1, wherein the reflective polarizer is aligned parallel to the perforated mask such that the reflective light component is rotated in terms of its polarization by two passages through the retarder and is superimposed on the directly transmitted component at the reflective polarizer as a result of the reflection at the perforated mask.
